(19) United States
(12) Patent Application Publication
(10) Pub. No.: US 2012/0267358 A1
(43) Pub. Date: Oct. 25, 2012

(54) INDUCTION HEATED HAIR ROLLERS

(75) Inventor: Adam Floyd, Derriford (GB)

(73) Assignee: NEXT ROW LIMITED, Ilkley Yorkshire (GB)

(21) Appl. No.: 13/511,946

(22) PCT Filed: Aug. 5, 2010
(86) PCT No.: PCT/GB10/51294

§ 371 Date: May 24, 2012

(30) Foreign Application Priority Data
Aug. 5, 2009 (GB) 0913703.5

(51) Int. Cl. H05B 6/10; A45D 8/00

(52) U.S. Cl. 219/635

(57) ABSTRACT

A hair roller which can be heated by induction has a cylindrical core (1) formed of ferromagnetic material enclosed within a heat storage layer (2) which is heated by conduction from the core. The layer (2) is formed of cellular silicone rubber which modifies the rate of heat transfer to an outer gripping layer (4). An end cap (5) incorporates a thermo-sensitive substance (10) which changes colour when the roller is heated to its working temperature. The roller can be handled immediately after heating and provides a sustained level of heat output.

### TECHNICAL FIELD OF THE INVENTION

This invention relates to hair rollers which are capable of being heated by electromagnetic induction.

### BACKGROUND

Induction heating is a process by which electrically conducting objects, usually of metal, are heated by placing the object in the field of an induction coil fed with a high-frequency pulsed or alternating current. Electromagnetic induction causes eddy currents to be generated within the metal which undergoes Joule heating due to its electrical resistance. In materials that have significant relative permeability, heat may also be generated by magnetic hysteresis losses.

The use of electromagnetic induction to heat rollers for hair styling is already known and provides several significant advantages over conduction heating, principally a very short warm-up time and avoidance of residual high temperatures in the heating unit. U.S. Pat. No. 4,499,355 discloses a hair roller which comprises a cylindrical plastics body lined with a core of high permeability metal. When the core is heated by induction the outer body warms up by thermal conduction and acts as a heat store. In order to facilitate handling, the inside of the plastics body is provided with axial ridges which delay transfer of heat from the metal core.

Such an arrangement has significant disadvantages. Much of the heat will be lost from the core without ever being transferred to the outer body and is therefore wasted. Furthermore, once heated, the rate of heat loss from the outer body is relatively high so that the roller cools down quickly in use.

Other hair rollers having a metal core surrounded by a moulded outer body are disclosed in GB 1 338 954 and also in JP 5 146 310 A in which the outer body is covered by a layer of cloth.

The present invention seeks to provide a new and inventive form of hair roller which can be handled as soon as the heating process is completed whilst making efficient use of the heat generated and providing a sustained useable period.

### SUMMARY OF THE INVENTION

The present invention proposes a hair roller having:
a hollow core formed of a material which can be heated by electromagnetic induction;
a heat storage layer, which can be heated by conduction, surrounding the hollow core; and
an outer gripping layer covering the heat storage layer;
   characterised in that

the heat storage layer comprises a resilient cellular material which modifies the rate of heat transfer from the hollow core to the outer gripping layer.

The roller initially exhibits a low temperature rise at the outer layer to facilitate handling but maintains a good temperature for an extended period. The resilient cellular material provides the necessary temperature regulation properties and also improves the comfort of the roller in use.

The resilient cellular material may be provided as a separate layer covering the heat storage layer, or incorporated into the heat storage layer itself.

To ensure efficient heat transfer the opposing surfaces of the core and the heat storage layer are preferably in mutual contact over substantially their entire area.

The outer gripping layer preferably incorporates a plastics mesh having numerous projections, which ensures good grip and heat transfer to the hair.

### BRIEF DESCRIPTION OF THE DRAWINGS

The following description and the accompanying drawings referred to therein are included by way of non-limiting example in order to illustrate how the invention may be put into practice. In the drawings:

FIG. 1 is a general view of a hair roller in accordance with the invention; and

FIG. 2 is an exploded perspective view of the hair roller.

### DETAILED DESCRIPTION OF THE DRAWINGS

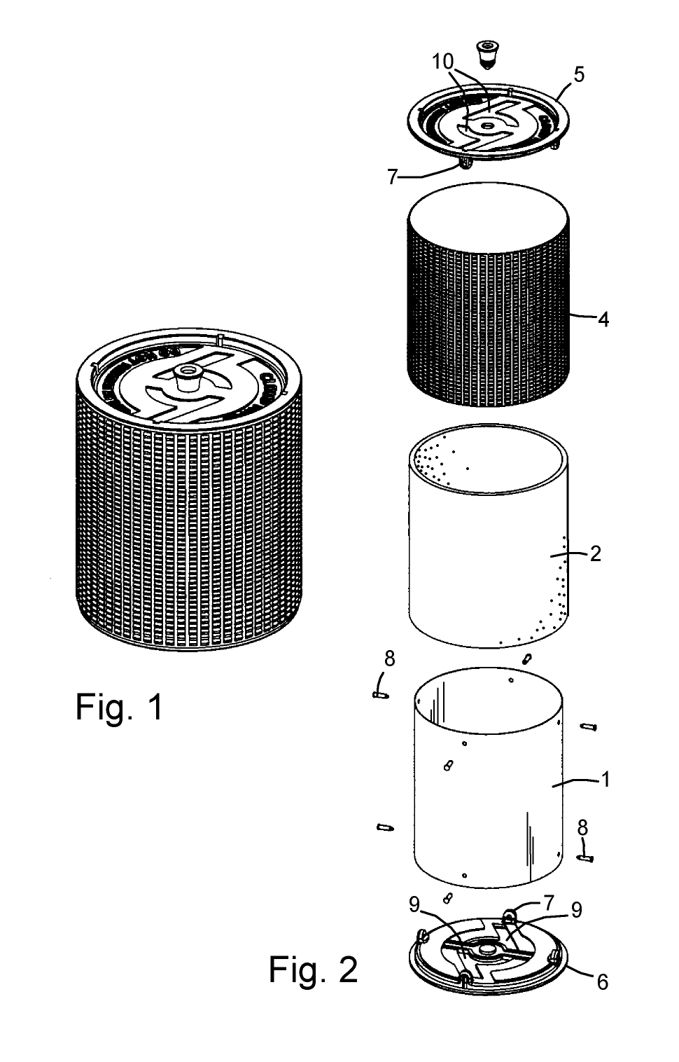

Referring firstly to FIG. 1, the hair roller is of hollow cylindrical shape closed by top and bottom end caps.

The structure of the roller can be seen in greater detail in FIG. 2. An inner cylindrical metal core 1 is surrounded by a heat storage member 2, and an outer gripping layer 4. The cylindrical body is closed by opposite end caps 5 and 6 each having lugs 7 projecting into the metal core 1, to which the lugs are secured by rivets 8. One of the end caps 6 may have ventilation apertures 9. The opposite end cap may be provided with areas 10 of thermo-sensitive indicator paint or a similar substance which changes colour, e.g. from black to red, when the roller attains its working temperature.

The metal core 1 allows the roller to be heated by induction when placed within a suitable induction heating coil, and is formed of a high permeability ferromagnetic material such as low carbon steel. Other high permeability metals could be used such as nickel, cobalt, aluminium, manganese, chromium or iron. When an alternating current is induced in the core it acts as a single shorted turn causing eddy currents to be generated within the metal which cause the core to rapidly heat up due to Joule heating and magnetic hysteresis losses. Since, due to the skin effect, the circulating currents mainly flow at the surface of the core the metal core need only be thin, as shown, so that the weight of the roller is kept low. Typically the wall thickness of the core 1 will be in the range of 0.05 mm to 0.5 mm.

The heat storage member 2 is electrically non-conductive but is capable of being heated by conduction from the core 1 with which the member 2 is in close thermal contact over their opposing faces. The wall of the heat storage member will normally be thick relative to that of the core 1, typically between 1.0 and 1.5 mm, providing a relatively large thermal mass.

The heat storage member 2 is provided in the form of a sleeve located axially between the outer edges of the end caps 5 and 6. The sleeve 2 is formed of a soft elastomeric material such as sponge silicone rubber which delays the release of heat from the member 2 to the gripping layer 4. The wall thickness of the sleeve may typically be between 1.0 and 2.0 mm. The outer gripping layer 4 may be formed from a known material for covering hair rollers such as a plastics mesh carrying numerous projections which act to hold the rollers to the hair in use.

The caps 5 and 6 assist in retaining the heat inside the roller. The caps may be moulded of a suitable non-electrically-conductive thermoplastic and prevent direct hand contact with the hot core.

When electromagnetically coupled to a pulsed or alternating field of suitable frequency and strength, the metal core 1 will quickly heat up in known manner. Due to their close mutual coupling the core 1 immediately transfers heat to the member 2, but the cellular layer delays the transfer of heat to the outer layer 4 so that the roller remains relatively cool to handle during an initial period of up to a minute. The cellular layer allows the controlled release of heat stored within the spongy material so that eventually, when the roller has been applied to the hair, the outer surface of the roller will become warm, and remains so for a prolonged period.

Whilst the above description places emphasis on the areas which are believed to be new and addresses specific problems which have been identified, it is intended that the features disclosed herein may be used in any combination which is capable of providing a new and useful advance in the art.

1. A hair roller having:
a hollow core (1) formed of a material which can be heated by electromagnetic induction;
a heat storage layer (2), which can be heated by conduction, surrounding the hollow core; and
an outer gripping layer (4) covering the heat storage layer;
characterised in that
the heat storage layer (2) comprises a resilient cellular material which modifies the rate of heat transfer from the hollow core (1) to the outer gripping layer (4).

2. A hair roller according to claim 1 in which the opposing surfaces of the hollow core (1) and the heat storage layer (2) are in mutual contact over substantially their entire area.

3. A hair roller according to claim 1 in which the heat storage layer (2) is formed or an elastomer.

4. A hair roller according to claim 1 in which the outer gripping layer (4) incorporates a plastics mesh having numerous projections.

5. A hair roller according to claim 1 which includes an end cap (5) incorporating a thermo-sensitive substance (10) which changes colour when the roller is heated to its working temperature.
